(19) United States
(12) Patent Application Publication
(10) Pub. No.: US 2005/0007931 A1
(43) Pub. Date: Jan. 13, 2005

(54) Optical pickup device

(75) Inventors: Katsuya Sakamoto, Tokyo (JP); Kiyoshi Yamashita, Tokyo (JP); Kohei Ota, Tokyo (JP); Yuichi Atarashi, Tokyo (JP); Hidekazu Totsuka, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 10/882,617

(22) Filed: Jul. 1, 2004

(30) Foreign Application Priority Data
Jul. 11, 2003 (JP) JP2003-195793
Feb. 9, 2004 (JP) JP2004-032114
Mar. 31, 2004 (JP) JP2004-105271

(51) Int. Cl. G11B 7/00

(52) U.S. Cl. 369/112.01; 369/112.23

(57) ABSTRACT

An optical pickup apparatus having a light source unit including a plurality of light emitting, a beam regulating element to regulate a light flux emitted from the light source unit so that the an angle of divergence of the light flux emitted from the light source unit is changed to a first direction and/or a second direction, wherein a distance from each of the light emitting element to a surface of a protective layer that protects the recording surface is constant regardless a type of the optical information recording medium.

### RELATED APPLICATION

This application is based on patent application(s) No(s). 2003-195793, 2004-32114 and 2004-105271 filed in Japan, the entire content of which is hereby incorporated by reference.

### BACKGROUND

1. Field of the Invention

The present invention relates to an optical pickup device having compatibility for two or more kinds of optical information recording media.

2. Description of the Related Art

There have recently been proposed various types of optical pickup devices each having the so-called compatibility wherein reading and writing for each optical disc can be conducted by irradiating light fluxes each having a different wavelength from two or more light sources to recording surfaces of two or more types of optical information recording media (optical discs) and by conducting light converging with one objective lens.

As a light source of the optical pickup device, a laser diode (semiconductor laser) is generally used. In the case of the semiconductor laser, a longitudinal ratio is different from a lateral ratio in the active area, and therefore, an angle of divergence of a beam (full angle at half maximum) in the direction perpendicular to the composition surface is different from that in the horizontal direction, and in many cases, a section on the surface perpendicular to the optical axis turns out to be oval-shaped, resulting in uneven intensity distribution such as Gaussian distribution.

Therefore, there have been disclosed a technology to regulate a sectional shape of a light flux from an oval shape to a circle and a technology to convert uneven intensity distribution into substantially uniform intensity distribution (for example, Japanese laid-open patents No. HEI 6-294940 and No. 2000-089161).

Incidentally, following upon recent demands for downsizing and higher functions of an optical pickup device, there is sometimes an occasion to use a light source (hereinafter referred to as “light source unit”) in which a plurality of diodes each having high generating power are arranged to be close each other to be united (into one unit).

In the optical pickup device employing the light source unit, a light-emitting point of each light flux is positioned to be equal to others substantially, and thereby, each of an optical path length (distance between an object and an image) and a magnification of the optical system is substantially equal to others.

Now, when a light flux with wavelength 780 nm used for CD (compact disc) is compared with a light flux with wavelength 650 nm used for DVD (digital versatile disc), for example, a numerical aperture (NA) of the objective lens for DVD is greater than that for CD, although an angle of divergence is almost the same for both of them. Under the condition that DVD is substantially the same as CD in terms of the optical system magnification, therefore, there is caused a problem that the rim intensity of the light flux for DVD falls below the intensity (about 60-70%) which is necessary as standards.

Incidentally, the conventional technology is one related to an optical pickup device having no compatibility to be used only for one type of light flux, and it is difficult to use this technology for an optical pickup device that has compatibility and uses two or more types of light fluxes each having a different wavelength. Further, though Japanese laid-open patent No. HEI 6-294940 discloses a technology capable of being applied also to an optical device having one or more diode lasers, it does not disclose a method of solving the aforementioned problem in the case of using, as a light source, a light source unit wherein the optical system magnification of each light flux is the same each other.

### SUMMARY

In view of the problem stated above, an object of the invention is to provide an optical pickup device which can conduct properly the regulation of a sectional shape of each light flux and conversion of intensity distribution, even in the case of using a light source unit wherein a plurality of light-emitting elements are provided to be close each other.

The object of the invention stated above is attained when there are provided a light source unit including a plurality of light emitting elements provided to be closed each other, wherein each of the light emitting elements emits a light flux, wherein the light fluxes have a different wavelength each other, a beam regulating element to regulate the light flux emitted from the light source unit so that the an angle of divergence of the light flux emitted from the light source unit is changed to a first direction and/or a second direction, wherein the first direction is perpendicular to an optical axis, and the second direction is perpendicular to both of the optical axis and the first direction, a coupling element to convert the angle of divergence of the light flux, an objective optical element to converge the light flux coming from the coupling element on an recording surface of an optical information recording medium to form a light-converged spot on the optical information recording medium, and a light-receiving element to receive reflected light from the light-converged spot so that the light-receiving element converts the reflected light into an electric signal, wherein a distance from each of the light emitting element to a surface of a protective layer that protects the recording surface is constant regardless a type of the optical information recording medium, and a first light flux is used to form the light-converged spot for the optical information recording medium having a thick protective layer, while, a second light flux is used to form the light-converged spot for the optical information recording medium having a thin protective layer, wherein the first light flux has a longer wavelength than the light fluxes except for the first light flux, and the second light flux has a shorter wavelength than the light fluxes except for the second light flux.

Incidentally, in the present specification, “a distance from each light-emitting point to the surface of a protective layer that protects the recording surface is set to be constant regardless optical information recording media” means that a distance from the light-emitting point emitting the first light flux to the surface of a protective layer in a straight line and a distance from the light-emitting point emitting the second light flux to the surface of a protective layer in a straight line are kept to be equal each other, owing to the structure of the optical pickup device. In this case, there is supposed an occasion where errors in incorporating a rotary driving device that holds each light-emitting point and an optical information recording medium rotatably make the aforesaid two distances not to be the same in a strict sense. However, even in the case where the aforesaid two distances are changed by the incorporating errors, these distances are assumed to be the same in the present specification.

As an ordinary light source unit, there are known a type of implementation with the structure where separate laser diodes are arranged at positions which are close to each other and a type to form a plurality of laser diodes each being made of different on the same base board, and these types are included in the light source unit in the present specification.

In addition to CD and DVD, the optical information recording medium includes optical discs in various standards with different light source wavelength and protective base board thickness such as ordinary optical discs including CD-R (recordable compact disk), CD-RW (rewritable compact disk), VD (video disc), MD (mini disc) and MO (magneto-optical disc), for example, and it also includes, as a light source for recording/reproducing of information, a high density optical disc employing a violet semiconductor laser or a violet SHG laser with wavelength of about 400 nm. It is assumed that a high density optical disc also includes an optical disc (hereinafter referred to as HD-DVD) in the standard of a protective layer thickness of about 0.6 mm for which recording/reproducing of information is conducted by an objective optical system having NA of about 0.65, in addition to an optical disc in the standard of a protective layer thickness of about 0.1 mm for which recording/reproducing of information is conducted by an objective optical system having NA of about 0.85.

The invention makes it possible to form a shape of a section of each light flux into an optional shape even when optical system magnification is made to be the same by using the light source unit wherein a plurality of light-emitting points are provided to be close each other, thus, a grade of each light flux can be enhanced and forming of an excellent light-converged spot can be realized.

Further, the beam regulating element and the coupling element may also be united solidly.

Or, the beam regulating element and the coupling element may be composed of one element that has functions of both of them.

An optical pickup device can be made small by uniting the beam regulating element and the coupling element solidly.

The beam regulating element and the objective optical element may also be provided separately each other.

All of the beam regulating element, the coupling element and the objective optical element may be made of plastic. When respective optical elements are made of plastic, manufacture of them becomes easier and manufacturing cost can be controlled, compared with an occasion to use glass for manufacturing.

The object of the invention stated above is attained when there are provided a light source unit including a plurality of light emitting elements provided to be closed each other, wherein each of the light emitting elements emits a light flux, wherein the light fluxes have a different wavelength each other, a light intensity distribution converting element to convert a light intensity of a light flux to the desired light intensity within a range of 45-95% of the light intensity of the light flux passing through the optical axis position, wherein the light flux is passed through the outermost peripheral portion of an effective diameter in the light fluxes emitted from the light source unit, and intensity distribution of the light fluxes emitted from the light source unit is substantially Gaussian distribution, a coupling element to convert the angle of divergence of the light flux, an objective optical element to converge the light flux coming from the coupling element on an recording surface of an optical information recording medium to form a light-converged spot on the optical information recording medium, and a light-receiving element to receive reflected light from the light-converged spot so that the light-receiving element converts the reflected light into an electric signal, wherein a distance from each of the light emitting element to a surface of a protective layer that protects the recording surface is constant regardless a type of the optical information recording medium, and a first light flux is used to form the light-converged spot for the optical information recording medium having a thick protective layer, while, a second light flux is used to form the light-converged spot for the optical information recording medium having a thin protective layer, wherein the first light flux has a longer wavelength than the light fluxes except for the first light flux, and the second light flux has a shorter wavelength than the light fluxes except for the second light flux.

The invention makes it possible to convert uneven intensity distribution into substantially uniform intensity distribution even when optical system magnification is made to be the same by using the light source unit wherein a plurality of light-emitting points are provided to be close each other, thus, a grade of each light flux can be enhanced and forming of an excellent light-converged spot can be realized.

Further, the light intensity distribution converting element and the coupling element may also be united solidly.

Or, the light intensity distribution converting element and the coupling element may be composed of one element that has functions of both of them.

An optical pickup device can be made small by uniting the light intensity distribution converting element and the coupling element solidly.

The light intensity distribution converting element and the objective optical element may also be provided separately each other.

All of the light intensity distribution converting element, the coupling element and the objective optical element may be made of plastic. When respective optical elements are made of plastic, manufacture of them becomes easier and manufacturing cost can be controlled, compared with an occasion to use glass for manufacturing.

The object of the invention stated above is attained when there are provided a light source unit including a plurality of light emitting elements provided to be closed each other, wherein each of the light emitting elements emits a light flux, wherein the light fluxes have a different wavelength each other, a beam regulating element to regulate the light flux emitted from the light source unit so that the an angle of divergence of the light flux emitted from the light source unit is changed to a first direction and/or a second direction, wherein the first direction is perpendicular to an optical axis, and the second direction is perpendicular to both of the optical axis and the first direction, a light intensity distribution converting element to convert a light intensity of a light flux to the desired light intensity within a range of 45-95% of the light intensity of the light flux passing through the optical axis position, wherein the light flux is passed through the outermost peripheral portion of an effective diameter in the light fluxes emitted from the light source unit, and intensity distribution of the light fluxes emitted from the light source unit is substantially Gaussian distribution, a coupling element to convert the angle of divergence of the light flux, an objective optical element to converge the light flux coming from the coupling element on an recording surface of an optical information recording medium to form a light-converged spot on the optical information recording medium, and a light-receiving element to receive reflected light from the light-converged spot so that the light-receiving element converts the reflected light into an electric signal, wherein a distance from each of the light emitting element to a surface of a protective layer that protects the recording surface is constant regardless a type of the optical information recording medium, and a first light flux is used to form the light-converged spot for the optical information recording medium having a thick protective layer, while, a second light flux is used to form the light-converged spot for the optical information recording medium having a thin protective layer, wherein the first light flux has a longer wavelength than the light fluxes except for the first light flux, and the second light flux has a shorter wavelength than the light fluxes except for the second light flux.

The invention makes it possible to form a shape of a section of each light flux into an optional shape and to change uneven intensity distribution to intensity distribution that is substantially uniform, even when optical system magnification is made to be the same by using the light source unit wherein a plurality of light-emitting points are provided to be close each other, thus, a grade of each light flux can be enhanced and forming of an excellent light-converged spot can be realized.

Further, the beam regulating element, the light intensity distribution converting element and the coupling element may also be united solidly.

Further, the beam regulating element, the light intensity distribution converting element and the coupling element may be composed of one element that has functions of all of them.

Further, the beam regulating element and the light intensity distribution converting element may also be united solidly.

Further, the beam regulating element and the light intensity distribution converting element may be composed of one element that has functions of both of them.

Further, the beam regulating element and the coupling element may also be united solidly.

Further, the beam regulating element and the coupling element may be composed of one element that has functions of both of them.

Further, the light intensity distribution converting element and the coupling element may also be united solidly.

Further, the light intensity distribution converting element and the coupling element may also be composed of one element that has functions of both of them.

An optical pickup device can be made small by uniting each element.

The beam regulating element and the objective optical element may also be provided separately each other.

Further, the light intensity distribution converting element and the objective optical element may also be provided separately each other.

All of the beam regulating element, the light intensity distribution converting element, the coupling element and the objective optical element may be made of plastic. When respective optical elements are made of plastic, manufacture of them becomes easier and manufacturing cost can be controlled, compared with an occasion to use glass for manufacturing.

Further, it is possible to provide a first optical path difference providing structure that provides a prescribed optical path difference to an incident light flux, on the optical surface of the objective optical element.

The first optical path difference providing structure may also be a diffractive structure.

It is also possible to arrange so that an occurrence of deterioration of wavefront aberration and/or astigmatism caused by temperature changes in working environment and/or wavelength changes of incident light flux may be restrained.

It is further possible to arrange so that the objective optical element may have a function to restrict a numerical aperture of an emergent light flux.

The function to restrict a numeral aperture may also be realized by the second optical path difference providing structure that is formed at a prescribed area on the optical surface of the objective optical element and gives a prescribed optical path difference to an incident light flux to make the light flux to be a flare.

When a position in the optical axis direction of the objective optical element in the case of forming the light-converged spot by using the first light flux is made to be a standard position, it is also possible to arrange so that the objective optical element is moved toward the light source unit relatively to the standard position, when forming the light-converged spot by the use of the second light flux. By doing this, it is possible to restrain aberration that is caused when a thickness of a protective layer of each optical information recording medium is different from others.

It is also possible to arrange so that a section of the second light flux on a plane perpendicular to the optical axis at the moment when it is emitted from the light source unit may be in a shape of an oval whose minor axis is in the first direction and major axis is in the second direction, and rim intensity of the second light flux in the first direction may be within a range of 45-95%. By doing this, the second light flux can be used preferably for DVD.

The light-emitting point from which the second light flux is emitted can be arranged so that it agrees with the optical axis. By doing this, aberration caused on the second light flux can be restrained.

The optical axis magnification may also be within a range of x3-x5.

The light-receiving portion may also be arranged so that it may receive reflected light of the first light flux and reflected light of the second light flux in common. By doing this, a light-receiving portion for the first light flux and a light-receiving portion for the second light flux can be used in common, and reduction of manufacturing cost for optical pickup devices and downsizing thereof can be realized.

An optical path composing means that makes an optical path for the first light flux and that for the second light flux to agree with each other at the moment before these light fluxes enter the beam regulating element or the light intensity distribution converting element may also be provided. By doing this, diagonal incidence of a light flux can be prevented, and astigmatism can be restrained.

Further, the beam regulating element or the light intensity distribution converting element may also be arranged so that it has selectivity for the wavelength that gives an optical effect to an optional light flux among passing light fluxes. By doing this, it is possible to regulate a shape of a section and to convert light intensity distribution for each light flux, owing to the wavelength-selectivity, even when light fluxes of plural types each having a different wavelength are emitted from the light source unit.

It is further possible to arrange so that the optical effect stated above may be the effect to restrain astigmatism caused by diagonal incidence of the light flux and/or the effect to restrain astigmatism caused by a wavelength difference between the first light flux and the second light flux.

An arrangement may further be made so that the optical effect mentioned above may be given only to the first light flux.

The wavelength-selectivity may also be realized by the third optical path difference providing structure that gives a prescribed optical path difference to the incident light flux.

The third optical path difference providing structure may also be provided with a coma correcting structure wherein the first optical functional sections extending linearly in the third direction that is perpendicular to the optical axis on the optical surface are arranged continuously in the fourth direction that is perpendicular to the third direction.

When the direction of arrangement of respective light-emitting points provided on the light source unit is prescribed to be the fifth direction, an absolute value of an angle between the fourth direction and the fifth direction may also be made to be 30° or less.

The third optical path difference providing structure may also be provided with an astigmatism correcting structure wherein the second optical functional sections extending linearly in the sixth direction that is perpendicular to the optical axis on the optical surface are arranged continuously in the seventh direction that is perpendicular to the sixth direction.

When the direction of arrangement of respective light-emitting points provided on the light source unit is prescribed to be the fifth direction, an absolute value of an angle between the seventh direction and the fifth direction may also be made to be 300 or less.

The third optical path difference providing structure may also be provided with a coma correcting structure wherein the first optical functional sections extending linearly in the third direction that is perpendicular to the optical axis on the optical surface are arranged continuously in the fourth direction that is perpendicular to the third direction, and with an astigmatism correcting structure wherein the second optical functional sections extending linearly in the sixth direction that is perpendicular to the optical axis on the optical surface are arranged continuously in the seventh direction that is perpendicular to the six direction.

When the direction of arrangement of respective light-emitting points provided on the light source unit is prescribed to be the fifth direction, an absolute value of an angle between the fourth direction and the fifth direction may also be made to be 30° or less, an absolute value of an angle between the seventh direction and the fifth direction may also be made to be 30° or less, and an absolute value of an angle between the fourth direction and the seventh direction may also be made to be 15° or less.

When using an optical element wherein a coupling element and a light intensity distribution converting element are united solidly, there is a difference between wavelengths of light fluxes in two types (the first light flux and the second light flux) both emitted from the light source unit, which causes astigmatism resulted from the change in refractive index of the optical element, and further, when one of the light-emitting points which emit these light fluxes is arranged on the optical axis, the light flux emitted from the other light-emitting point results in off-axis light, which causes astigmatism. Therefore, by providing the coma correcting structure or the astigmatism correcting structure on the optical surface of the beam regulating element or of the light intensity distribution converting element, as the third optical path difference providing structure, these coma and astigmatism can be controlled.

It is also possible to arrange so that a shape of a section on a plane perpendicular to the optical axis of each light flux at the moment when the light flux is emitted from the light source unit may be in a shape of an oval whose minor axis is in the first direction and major axis is in the second direction, and 1.0<D2/D1<2.0 may be satisfied when D1 represents an angle of divergence in the first direction for the light flux after regulated by the beam regulating element and D2 represents an angle of divergence in the second direction. However, each of D1 and D2 is an angle at the position where the light intensity of each light flux is 50% of the peak value.

It is further possible to arrange so that a shape of a section on a plane perpendicular to the optical axis of each light flux at the moment when the light flux is emitted from the light source unit may be in a shape of an oval whose minor axis is in the first direction and major axis is in the second direction, and rim intensity in the first direction for the light flux converted by the light intensity distribution converting element may be within a range of 45-95%.

It is also possible to arrange so that the beam regulating element may be a cylindrical lens, and the direction of arrangement of the light-emitting points provided on the light source unit may agree with the direction of the axis of the beam regulating element.

Further, an optical axis of the beam regulating element may also be tilted from the vertical direction of the plane including the light-emitting points equipped on the light source unit.

The direction for inclination of the optical axis of the beam regulating element may also be made to agree with the direction for arrangement of the respective light-emitting points.

The beam regulating element may also be made to be in a form of a wedge wherein a plane of emergence is tilted relatively from a plane of incidence.

The direction for relative inclination of the plane of emergence from the plane of incidence may also be made to agree with the direction for arrangement of the respective light-emitting points.

A light-composing means that makes optical paths of at least the first light flux and the second light flux to agree with each other may also be provided.

Optical paths of the first light flux and the second light flux both have passed the light-composing means may also be tilted from the vertical direction of the plane including the respective light-emitting points provided on the light source unit.

The light-composing means may also be in a shape of a wedge wherein a plane of emergence is relatively tilted from a plane of incidence.

The beam regulating element may be arranged to be one wherein each light flux whose section in a plane perpendicular to the optical axis at the moment when the light flux is emitted from the light source unit is in a shape of an oval is enlarged in terms of diameter to be emitted.

The beam regulating element may be arranged to be one wherein each light flux whose section in a plane perpendicular to the optical axis at the moment when the light flux is emitted from the light source unit is in a shape of an oval is reduced in terms of diameter to be emitted.

An actuator that moves at least one of the beam regulating element and the light intensity distribution converting element depending on the type of the optical information recording medium may also be provided. By doing this, it is possible to give optical functions such as changing an angle of divergence and providing phase difference, for example, to the light flux emitted from the optical element, and thereby to correct aberration.

Further, the actuator may also be arranged to move at least one of the beam regulating element and the light intensity distribution converting element in the direction parallel to the optical axis. By doing this, astigmatism caused by a difference between wavelengths of incident light fluxes can be corrected.

The actuator may further be arranged to move at least one of the beam regulating element and the light intensity distribution converting element in the direction perpendicular to the optical axis. By doing this, coma caused by diagonal incidence of a light flux in the optical element can be corrected.

The actuator mentioned above may also be a piezoelectric actuator.

The invention makes it possible to obtain an optical pickup device wherein a shape of a section of each light flux can be regulated and intensity distribution can be converted properly even when using a light source unit in which a plurality of light-emitting points are provided to be close each other.

The invention itself, together with further objects and attendant advantages, will best be understood by reference to the following detailed description taken in conjunction with the accompanying drawings.

### BRIEF DESCRIPTION OF THE DWAWINGS

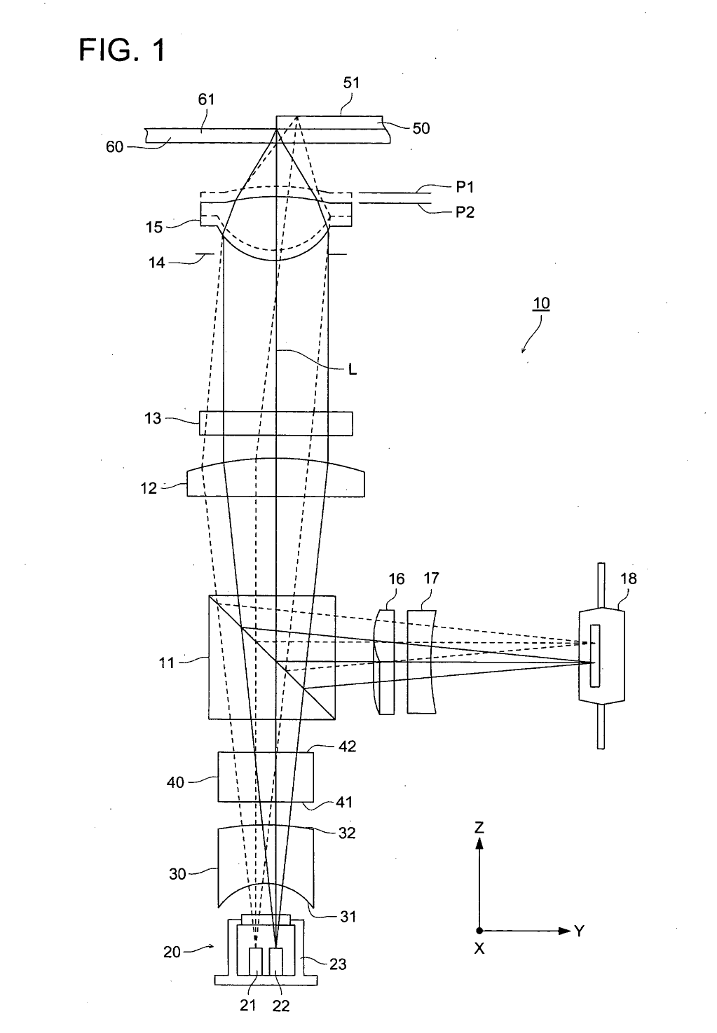

FIG. 1 is a plan view showing the structure of an optical pickup device relating to the invention.

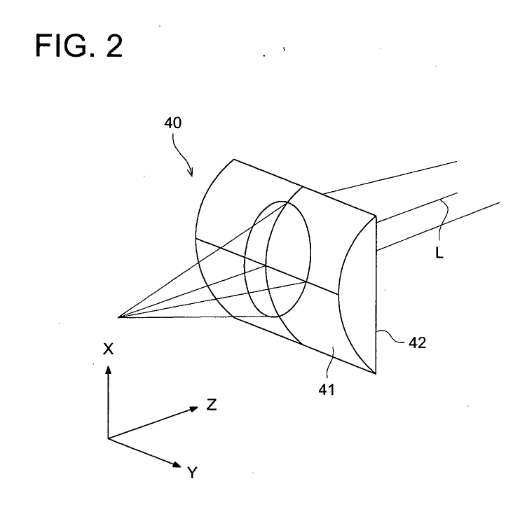

FIG. 2 is a perspective view of primary portions showing a form of a beam regulating element.

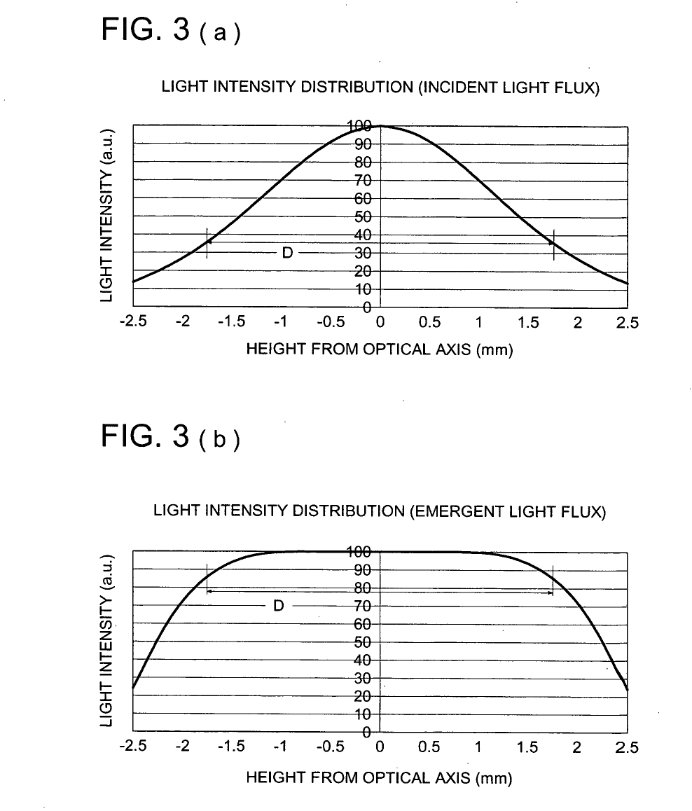

Each of FIGS. 3(a) and 3(b) is a graph showing light intensity distribution.

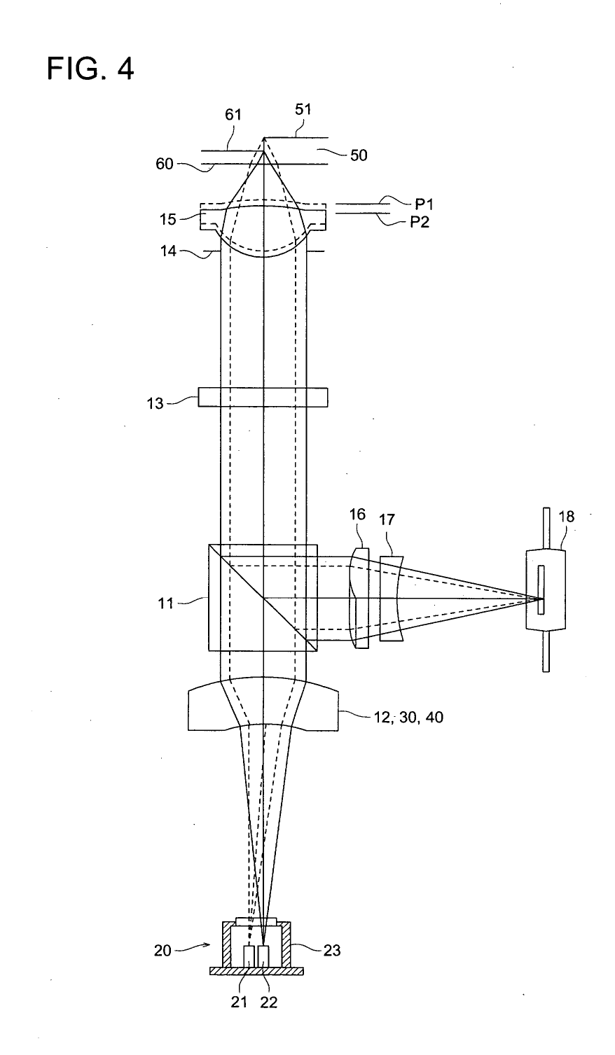

FIG. 4 is a plan view showing the another structure of an optical pickup device.

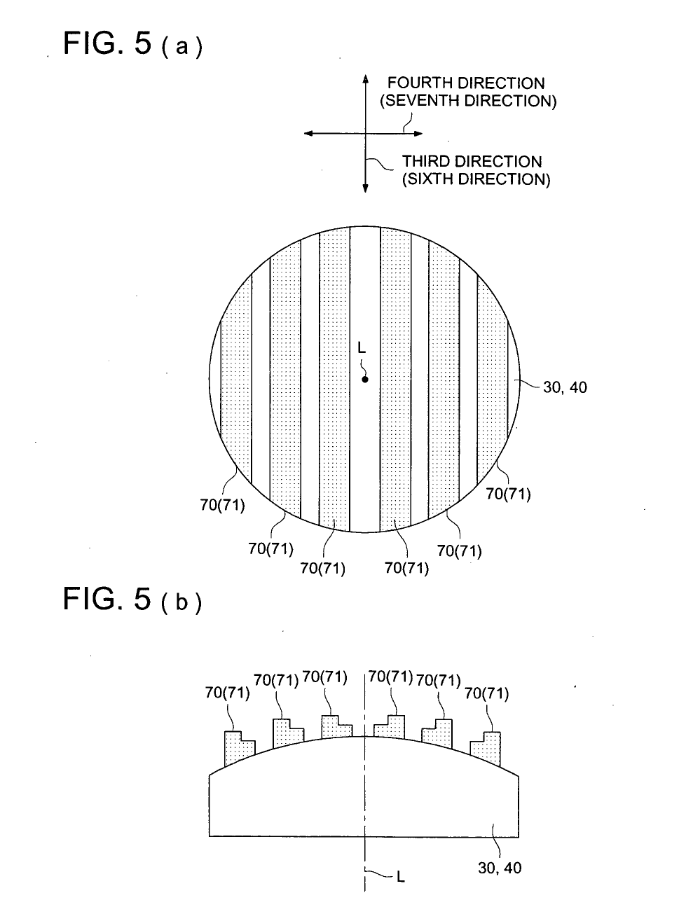

FIG. 5(a) is a front view and FIG. 5(b) is a plan view both showing forms of the third optical path difference providing structure.

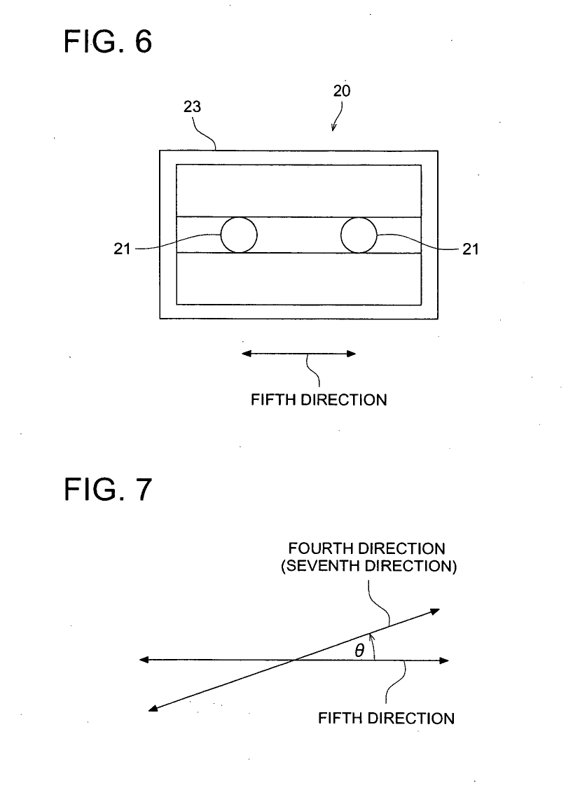

FIG. 6 is a front view for showing the structure of a light source unit.

FIG. 7 is a diagram for illustrating angle θ made between the fourth direction (seventh direction) and the fifth direction.

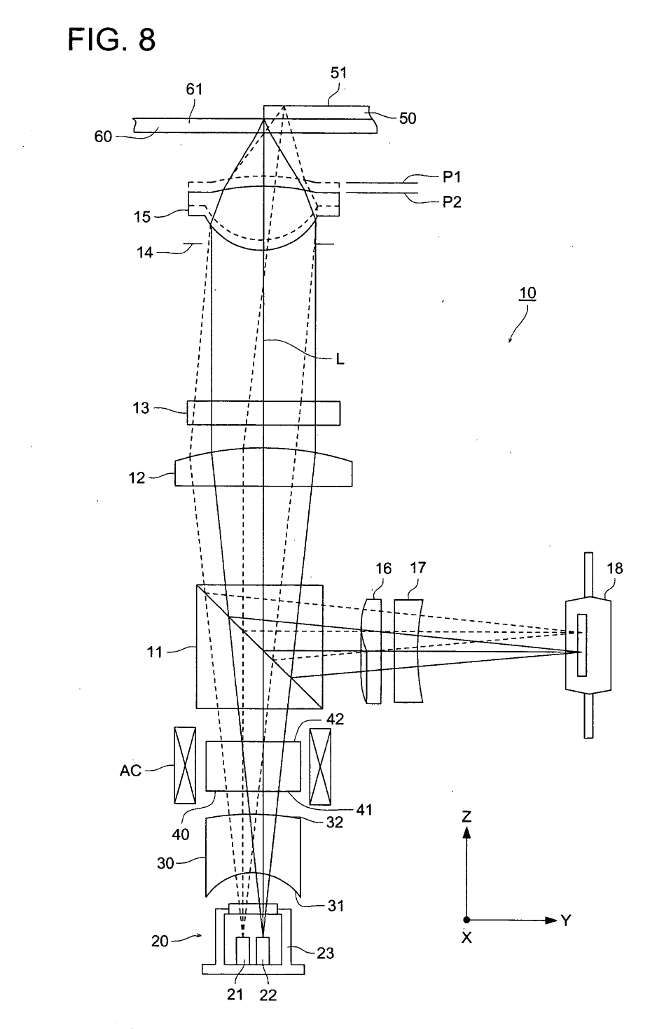

FIG. 8 is a plan view showing the structure of an optical pickup device relating to the invention.

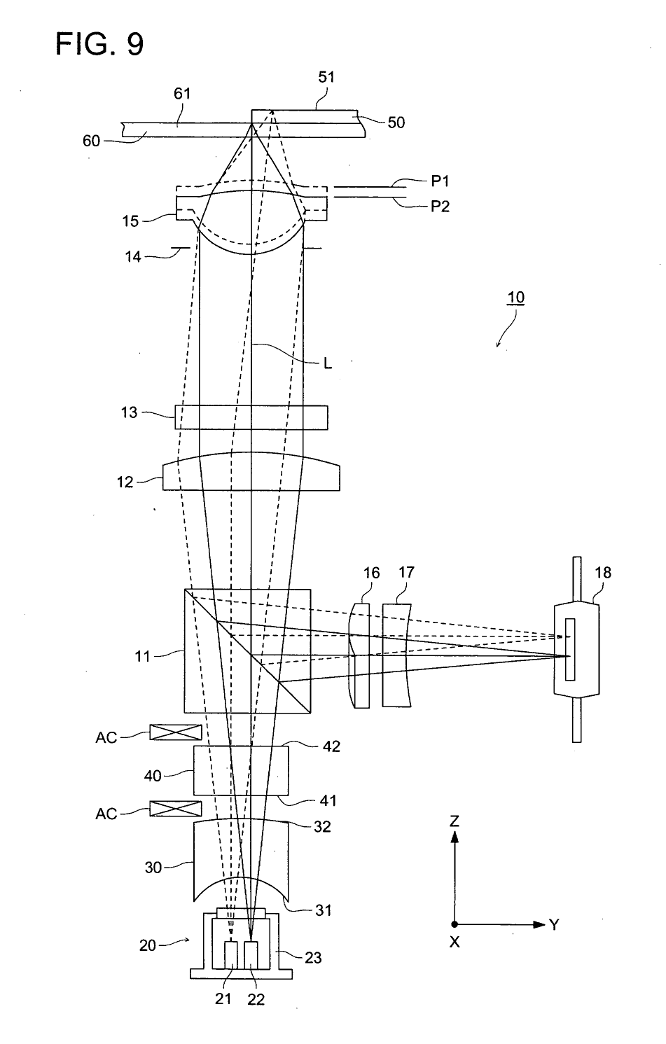

FIG. 9 is a plan view showing the structure of an optical pickup device relating to the invention.

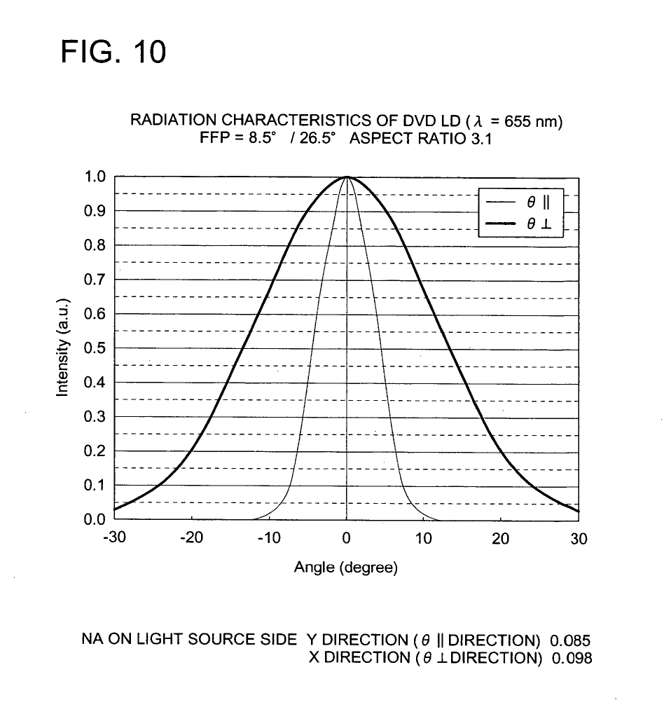

FIG. 10 is a graph showing radiation characteristics.

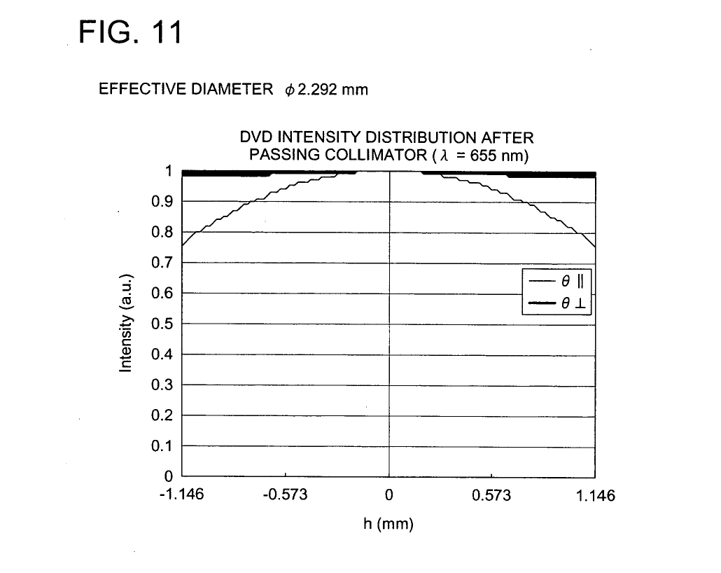

FIG. 11 is a graph showing radiation characteristics.

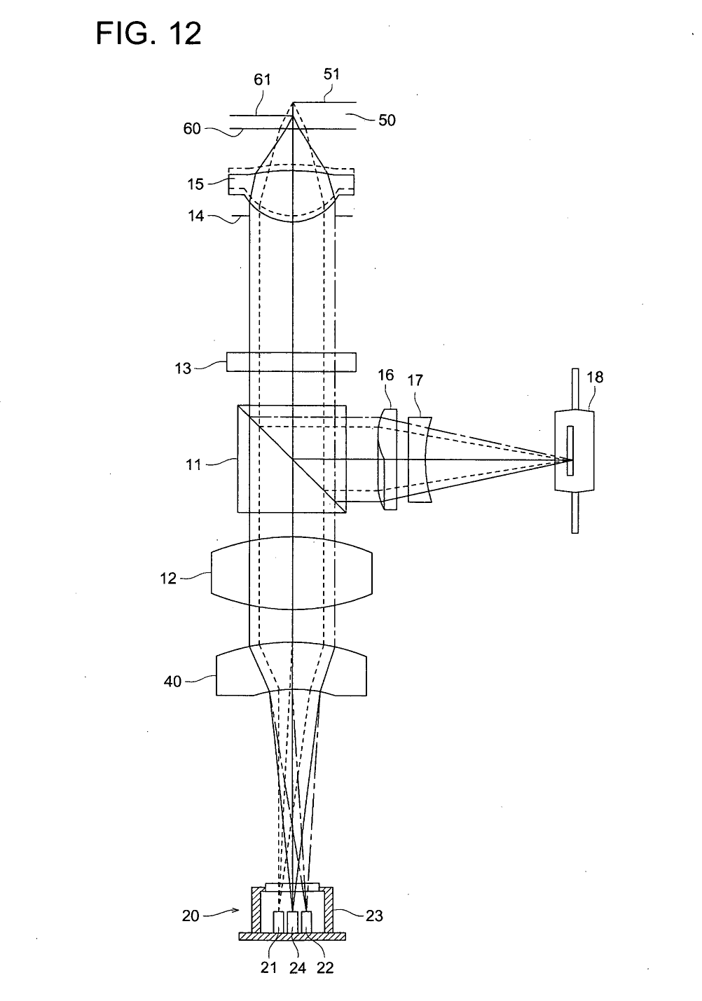

FIG. 12 is a plan view showing another structure of an optical pickup device.

In the following description, like parts are designated by like reference numbers throughout the several drawing.

### DESCRIPTION OF THE PREFERRED EMBODIMENT

An embodiment for working of optical pickup device 10 of the invention will be explained in detail as follows, referring to the drawings. Though the optical pickup device of the present embodiment has compatibility between DVD and CD, there may further be other structures, without being limited to the foregoing, including a structure having compatibility between a high density optical disc and DVD and a structure having compatibility for three types of optical discs of a high density optical disc, DVD and CD.

As shown in FIG. 1, optical pickup device 10 is substantially composed of light source unit 20, light intensity distribution converting element 30, beam regulating element 40, beam splitter 11, coupling element 12 (collimator in the present embodiment), ¼ wavelength plate 13, diaphragm member 14, objective lens 15, cylindrical lens 16, concave lens 17 and photosensor 18.

Incidentally, among the whole of optical elements used in the optical pickup device 10, all of them except beam splitter 11 are made of plastic.

The light source unit 20 is of the united structure wherein the first laser diode 21 (light-emitting point) that emits a light flux (first light flux) with wavelength λ1 used for CD and the second laser diode 22 that emits a light flux (second light flux, λ2<λ1) with wavelength λ2 used for DVD are arranged in the Y direction to be close each other. Incidentally, symbol 23 represents a casing having therein laser diodes 21 and 22.

When using the light source unit 20 of this kind, an optical path length (a distance between an object and an image) becomes the same as others substantially, and the optical system magnification becomes the same as others substantially, because a light-emitting point of each light flux agrees substantially with others in terms of a position. Incidentally, it is preferable that the optical system magnification is a range of x3-x5.

The first light flux emitted from the first laser diode 21 arranged at the position deviated slightly in the Y direction from the second laser diode 22 arranged on the optical axis enters each optical element diagonally, as shown with dotted lines in FIG. 1.

As shown in FIG. 2, light fluxes (the first light flux and the second light flux) emitted from the light source unit 20 respectively have angles of divergence which are different between the first direction (Y direction) perpendicular to optical axis L and the second direction (X direction) perpendicular to both of the optical axis L and the Y direction, and an XY section of the light flux is substantially in a shape of an oval whose minor axis is in the Y direction and major axis is in the Y direction. In FIG. 2, neither the light source unit 20 nor the light intensity distribution converting element 30 is illustrated.

FIG. 3(a) is a graph showing an example of a change rate of light intensity corresponding to a height (distance in the Y direction) from the optical axis in the case where the maximum value of light intensity is 100% for the light flux before entering the light intensity distribution converting element 30. The graph shows that the light flux has the Gaussian distribution.

The graph further shows that the light intensity (rim intensity) of the light flux passing through the outermost peripheral portion of an effective diameter of light intensity distribution converting element 30 (shown with D in FIG. 3(a)) among emergent light fluxes having Gaussian distribution is about 35% of the light intensity (100%) of the light flux passing through the optical axis position.

Next, operations of the optical pickup device 10 having the aforesaid structure.

The first light flux emitted from the light source unit 20 is first converted in terms of light intensity distribution in the light intensity distribution converting element 30, and then regulated in terms of shape of a section in the beam regulating element 40, to emerge therefrom. Incidentally, operations of the light intensity distribution converting element 30 and the beam regulating element 40 for the light flux in this case will be explained later.

Then, the light flux passes through beam splitter 11 and is transmitted through collimator 12 to become a parallel light flux. Then, it passes through ¼ wavelength plate 13 to be stopped down by diaphragm member 14, and passes through objective lens 15 to form a light-converged spot on recording surface 51 through protective base board 50 of CD. Incidentally, the position of the objective lens 15 in the optical axis direction (Z direction) in this case is assumed to be standard position P1.

Then, the light flux modulated by information pits and reflected on recording surface 51 passes again through the objective lens 15, diaphragm member 14, ¼ wavelength plate 13 and collimator 12, and is branched by the beam splitter 11. Then, it is given astigmatism by cylindrical lens 16, and passes through concave lens 17 to enter optical sensor 18, thus, signals of information recorded on CD are read and obtained by using signals outputted from the optical sensor 18.

The second light flux emitted from the light source unit 20 also is first converted in terms of light intensity distribution in the light intensity distribution converting element 30, and then regulated in terms of shape of a section in the beam regulating element 40, in the same way as in the first light flux, to emerge therefrom. Operations of the light intensity distribution converting element 30 and the beam regulating element 40 for the light flux in this case will be explained later.

Then, the light flux passes through beam splitter 11 and is transmitted through collimator 12 to become a parallel light flux. Then, it passes through ¼ wavelength plate 13 to be stopped down by diaphragm member 14, and passes through objective lens 15 to form a light-converged spot on recording surface 61 through protective base board 60 of DVD.

At this point in time, the objective lens 15 is driven by an unillustrated actuator to move toward standard position P1 that is closer to the light source unit 20 (P2). This results in the structure that restrains aberration caused by a thickness difference between a protective layer (protective base board) of CD and that of DVD.

Then, the light flux modulated by information pits and reflected on recording surface 61 passes again through the objective lens 15, diaphragm member 14, ¼ wavelength plate 13 and collimator 12, and is branched by the beam splitter 11. Then, it is given astigmatism by cylindrical lens 16, and passes through concave lens 17 to enter optical sensor 18 which is common to the first light flux, thus, signals of information recorded on DVD are read and obtained by using signals outputted from the optical sensor 18.

As shown in FIG. 1, the light intensity distribution converting element 30 in the present embodiment is composed of a single aspheric lens.

Plane of incidence 31 of the light intensity distribution converting element 30 is formed to be an aspheric surface that is symmetric about optical axis L, and it is designed so that a paraxial radius of curvature may be negative.

Plane of emergence 32 of the light intensity distribution converting element 30 is also formed equally to be an aspheric surface that is symmetric about optical axis L, and it is designed so that a paraxial radius of curvature may be negative, and an absolute value of a radius of curvature of the plane of emergence 32 may be smaller than that of the plane of incidence 31.

Further, with respect to the light intensity distribution converting element 30, when H1 represents a distance (height) of the incident light flux from optical axis L, θ1 represents an angle made by a light flux passing through the position of height H1 and the optical axis L, F1 represents a focal length, and sine condition dissatisfaction amount S1 is prescribed to be equal to H1/(F1×sin θ1)−1, a design is conducted to satisfy S1>0, namely, a design is conducted not to satisfy the sine condition.

Incidentally, a technology to change intensity distribution of the light flux by designing a lens group constituting an optical system is disclosed in Japanese laid-open patent No. SHO 63-188115, and it is known, therefore, detailed explanation will be omitted here.

By designing so that the sine condition dissatisfaction amount S1 of the light intensity distribution converting element 30 may be positive as stated above, the light flux is regulated to emerge so that light flux density on the area that is away from optical axis L on the part of the plane of emergence 32 may become greater (high density), and so that, on the contrary, light flux density on the area near the optical axis L may become smaller (low density), when the light flux enters the plane of incidence 31 of the light intensity distribution converting element 30 at the light flux density at regular intervals.

Due to this, as shown in FIG. 3(c), it is possible to convert rim intensity of the light flux passing through the outermost peripheral portion in the effective diameter of the light intensity distribution converting element 30 (shown with D) among emergent light fluxes having Gaussian distribution into the practically sufficient light intensity which is as high as about 85% of the light intensity of the light flux passing through the optical axis position.

Incidentally, it is preferable that the rim intensity of the second light flux in the X direction is in a range of 45-96%.

As shown in FIG. 2, beam regulating element 40 is composed of a refracting interface in a shape of a spherical surface wherein a radius of curvature for YZ plane of plane of incidence 41 is infinite and a radius of curvature for XZ plane is represented by r (r≠∞)

Plane of incidence 41 and plane of emergence 42 both of the beam regulating element 40 are designed so that 1.0<D2/D1<2.0 may be satisfied when D1 represents an angle of divergence of the light flux in the Y direction after the light flux has been regulated by beam regulating element 40, and D2 represents an angle of divergence in the X direction.

Therefore, by giving refracting functions to the incident light flux whose section is substantially in a shape of an oval with plane of incidence 41 and plane of emergence 42, and thereby, by making the light flux to emerge at angles of divergence which are different from those in incidence regarding X direction and Y direction, it is possible to regulate a shape of a section of the light flux to be in an optional shape (for example, a circle) so that the light flux may emerge.

As stated above, in the optical pickup device 10 shown in the present embodiment, it is possible to regulate a shape of a section of each light flux into an optional shape, to convert uneven intensity distribution into substantially uniform intensity distribution, to enhance the grade of each light flux and to realize forming of excellent light-converged spot.

Incidentally, the optical pickup device 10 of the invention can be modified according to circumstances, within a range of the spirit and scope of the invention.

For example, though the optical pickup device 10 has therein the beam regulating element 40 and the light intensity distribution converting element 30 in the aforementioned embodiment, the invention is not limited to this, and the structure having either one of them may also be employed.

Further, though the aforementioned embodiment has the structure wherein the beam regulating element 40, the light intensity distribution converting element 30 and the coupling element 12 are arranged as a separate optical element, it is possible to modify according to circumstances, without being limited to the foregoing, including, for example, uniting the light intensity distribution converting element 30 and the coupling element 12 solidly by giving the light intensity distribution converting element 30 the function to convert an angle of divergence of an emergent light flux, and uniting these three elements solidly as shown in FIG. 4.

Further, a first optical path difference providing structure (illustration omitted) that gives a prescribed optical path difference to an incident light flux may also be formed on an optical surface of the objective lens 15. As the first optical path difference providing structure, there are given the following structures; a diffractive structure composed of a step increment structure wherein serrated diffractive ring-shaped zones each having its center on the optical axis or plural ring-shaped zones each having its center on the optical axis are continued through steps which are substantially in parallel with the optical axis, and a phase shift structure wherein plural ring-shaped zones each having its center on the optical axis are continued through steps which are substantially in parallel with the optical axis and a phase of each light flux passing through each ring-shaped zone is substantially made uniform on the recording surface of each optical information recording medium.

Owing to this, deterioration of wavefront aberration and/or astigmatism caused by temperature changes in working environment and/or wavelength changes in a light flux can be restrained by the use of diffracted light by diffractive ring-shaped zones.

Further, a second optical path difference providing structure (illustration omitted) that makes a light flux to be a flare by giving a prescribed optical path difference to an incident light flux may also-be provided on a prescribed area of an optical surface of objective lens 15. As the second optical path difference providing structure, there are given a diffractive structure identical to the first optical path difference providing structure and a phase shift structure. Due to this, the light flux passing through the prescribed area among light fluxes each entering the objective lens 15 can be made a flare that has the so-called aperture restricting function that does not contribute to forming light-converged spot.

Though the aforementioned embodiment has the structure wherein the first light flux enters each optical element diagonally, it is also possible to arrange an optical path composing means (illustration omitted) that makes an optical path for the first light flux and that for the second light flux to agree with each other at the moment before these light fluxes enter the beam regulating element 40 or the light intensity distribution converting element 30. As the optical path composing means, an optical system employing an integrated prism such as a beam regulating element disclosed in Japanese laid-open patent No. HEI 11-232685, for example, can be used. Due to this, diagonal entering of the light flux can be prevented, and coma can be restrained.

In addition, the beam regulating element 40 or the light intensity distribution converting element 30 may also have wavelength-selectivity that gives optical functions to an optional light flux among passing light fluxes.

AS the optical functions, there are given the functions to restrain coma caused by diagonal incidence of a light flux and the functions to restrain astigmatism caused by a difference of wavelength between the first light flux and the second light flux.

The wavelength-selectivity is one realized by forming the third optical path difference providing structure that gives prescribed optical path difference to the incident light flux, for example, on the optical surface of the beam regulating element 40 or the light intensity distribution converting element 30, and as the third optical path difference providing structure, there are given a diffractive structure identical to the aforementioned first optical path difference providing structure and a phase shift structure.

Further, as the third optical path difference providing structure, there is given a structure (coma correcting structure) wherein the first optical function portion 70 extending straight along the direction (third direction) perpendicular to optical axis L is arranged continuously in the direction (fourth direction) perpendicular to the third direction, on the optical surface of the beam regulating element 40 or the light intensity distribution converting element 30, as shown in FIG. 5. In this case, it is preferable that an absolute value of angle θ between the direction (fifth direction) of arrangement for the first laser diode 21 and the second laser diode 22 provided on light source unit 20 and the aforesaid fourth direction is 30° or less as shown in FIG. 6 and FIG. 7, namely, it is preferable that both directions agree substantially with each other in terms of direction. Incidentally, as shown in FIG. 7, the positive direction of the angle θ is assumed to be a direction which is counterclockwise from the fifth direction representing the standard. As stated above, the first laser diode 21 is arranged to be deviated slightly in the Y direction (fifth direction in FIG. 6), while, the second laser diode 22 is arranged on the optical axis L, and therefore, the first light flux emitted from the first laser diode 21 enters each optical element diagonally, thus, coma caused by the diagonal incidence is generated. It is therefore possible to correct the coma mentioned above by providing the third optical path difference providing structure on the beam regulating element 40 or the light intensity distribution converting element 30, and thereby, by giving a prescribed optical path difference to the first light flux that passes the first optical function portion 70 formed continuously in the fourth direction.

Further, in the same way, a structure (astigmatism correcting structure) wherein the second optical function portion 71 extending straight along the direction (sixth direction) perpendicular to the optical axis is arranged continuously in the direction (sixth direction) perpendicular to the optical axis L may be provided on the optical surface of the beam regulating element 40 or the light intensity distribution converting element 30, as the third optical path difference providing structure. In this case, it is preferable that an absolute value of angle θ between the fifth direction and the seventh direction is 30° or less, namely, it is preferable that both directions agree substantially with each other in terms of direction. It is possible to correct astigmatism caused by a wavelength difference between the first light flux emitted from the first laser diode 21 and the second light flux emitted from the second laser diode 22, by providing a prescribed optical path difference to each light flux passing through the second optical function portion 71.

Incidentally, the coma correcting structure and the astigmatism correcting structure may also be provided on the same optical surface. In this case, it is preferable that an absolute value of an angle between the fourth direction and the seventh direction is 15° or less. Due to this, it is possible to restrain the coma and the astigmatism stated above to the level which is not problematic practically.

Wavelength-selectivity may be realized by coating on an optical surface a multi-layer having functions to transmit only a light flux having a prescribed wavelength and to reflect the other light sources. Or, it may also be realized by making a shape of the optical surface to be asymmetric about an optical axis representing the center.

Due to this, a shape of a section of each light flux can be regulated and light intensity distribution can be converted, even when a plurality of light fluxes each having a different wavelength are emitted light source unit 20, for example.

With respect to a shape of the beam regulating element 40, it may be changed to, for example, a toroidal shape, a cylindrical shape and a wedge shape, according to circumstances.

When making a shape of an optical surface of the beam regulating element 40 to be a cylindrical shape, it is preferable that the direction (fifth direction, see FIG. 6) of arrangement of the first laser diode 21 and the second laser diode 22 both provided on light source unit 20 and the axial direction of the beam regulating element 40 are made to agree with each other. In particular, when optical pickup device 10 has compatibility between HD-DVD and DVD, numerical apertures NA of objective lens 15 for HD-DVD and for DVD are about 0.65, and therefore, the light intensity distribution converting element 30 is not always needed, and it is possible to correct the coma and astigmatism stated above by making the axial direction of beam regulating element 40 in a cylindrical form and the direction (fifth direction) of arrangement of the first laser diode 21 and the second laser diode 22 to agree with each other.

When making a shape of the beam regulating element 40 to be a wedge form wherein a plane of emergence is relatively tilted on a plane of incidence, it is preferable that the direction of relative inclination of the plane of emergence on the plane of incidence and the aforesaid fifth direction are made to agree with each other.

It is also possible to arrange a structure wherein the optical axis of the beam regulating element 40 is tilted to the direction vertical to the plane including the aforesaid fifth direction, and in this case, it is preferable to make the direction of inclination of the optical axis of the beam regulating element to agree with the fifth direction.

Incidentally, in the case of optical pickup device 10 having compatibility between HD-DVD and DVD, it is preferable that collimator 12 and beam regulating element 40 are arranged separately each other. As a type of the beam regulating element 40 in this case, there are given a type wherein a light flux whose section on a plane perpendicular to optical axis L at the point in time of emitting from light source unit 20 is in an oval shape is enlarged in terms of diameter to be emitted and a type wherein a light flux is reduced in terms of diameter to be emitted. When employing the type to enlarge a diameter, there is a merit that astigmatism can be made small, but an angle of divergence at the point in time of emitting from beam regulating element 40 grows greater and a focal length of collimator 12 that collimates the light flux becomes shorter, therefore, it is preferable to provide the third optical path difference providing structure on the collimator 12, while, when employing the type to reduce a diameter, there is a merit that astigmatism can be made small, but an angle of divergence at the point in time of emitting from beam regulating element 40 becomes smaller and a focal length of collimator 12 becomes longer, therefore, it is preferable to provide the third optical path difference providing structure on the beam regulating element 40.

Further, an optical path composing means that makes at least the first light flux and the second light flux to agree with each other may also be provided in the optical path of the optical pickup device, and in this case, it is preferable that the optical path of the first light flux and the second light flux which have passed the optical path composing means is tilted to the direction vertical to the plane including the fifth direction. The shape of the optical path composing means in this case is preferably a wedge form wherein the plane of emergence is tilted to the plane of incidence.

As a means to attain a function to restrain coma caused by diagonal incidence of a light flux and a function to restrain astigmatism caused by a wavelength difference between the first light flux and the second light flux which are owned by the light intensity distribution element 30 or by the beam regulating element 40, there is given a method to move the beam regulating element 40 or the light intensity distribution element 30 in the prescribed direction with an actuator.

For example, FIG. 8 is one showing the optical pickup device wherein an actuator for moving the beam regulating element 40 in the optical axis direction is added to the structure of the pickup device 10 in FIG. 1.

As the actuator, there are given, for example, a conventional rotary motor and a piezoelectric actuator disclosed in Japanese laid-open patent No. HEI 6-123830.

By moving the beam regulating element 40 in the optical axis direction, astigmatism caused by a wavelength difference between the first light flux emitted from the first laser diode 21 and the second light flux emitted from the second laser diode 22 can be corrected. Incidentally, the same effect as in the foregoing can also be obtained when the light intensity distribution converting element 30 is moved in the optical axis direction.

For example, FIG. 9 shows an optical pickup device wherein an actuator for moving the beam regulating element 40 in the direction perpendicular to the optical axis is added to the structure of optical pickup device 10 shown in FIG. 1.

By moving the beam regulating element 40 in the direction perpendicular to the optical axis, it is possible to correct coma that is caused when the first light flux emitted from the first laser diode 21 enters each optical element diagonally. Incidentally, the same effect as in the foregoing can also be obtained when the light intensity distribution converting element 30 is moved in the optical axis direction.

Since the effect to restrain the coma and astigmatism can be obtained only by providing the third optical path difference providing structure on the beam regulating element 40 or on the light intensity distribution converting element 30, it is possible to improve effects to restrain coma and astigmatism by moving the beam regulating element 40 or the light intensity distribution converting element 30 on which the third optical path difference providing structure is provided in the optical axis direction or in the direction perpendicular to the optical axis, by the use of an actuator.

Next, examples will be explained.

### EXAMPLE 1

An optical pickup device in the present example is the same in terms of structure as one shown in FIG. 4. Specifically, the optical pickup device is one having compatibility between CD and DVD. In the light source unit, there are stored the first laser diode and the second laser diode. The first laser diode emits the first light flux having a wavelength of 785 nm for CD. The second laser diode emits the second light flux having a wavelength of 655 nm for DVD. Each light flux emitted from the light source unit passes through the element wherein a beam regulating element, a light intensity distribution converting element and a collimator (coupling element) are united solidly, and then, passes through a beam splitter and ¼ wavelength plate, and a diameter of the light flux is stopped down by a diaphragm member to be converged on a recording surface of each optical disc through an objective lens.

Lens data of each optical element are shown in Table 1 and Table 2.

TABLE 1
Example Lens data

| | |
|---|---|
| 655 nm | 785 nm |

| | X | Y | X | Y |
|---|---|---|---|---|
| Coordinates of | 0.000 | 0.000 | 0.000 | 0.110 |
| light-emitting | | | | |
| point (mm) | | | | |
| NA on the object | 0.098 | 0.085 | 0.083 | 0.070 |
| point side | | | | |
| NA on the image | 0.597 | 0.597 | 0.513 | 0.513 |
| point side | | | | |

| | | |
|---|---|---|
| Wavefront | 0.004λ | 0.008λ |
| aberration | | |

| i^{th} | | | | | | |
|---|---|---|---|---|---|---|
| sur- | | | di | ni | di | ni |
| face | ryi | rxi | (655 nm) | (655 nm) | (785 nm) | (655 nm) |
| 0 | | | 10.0072 | | 10.0072 | |
| 1 | −0.8277 | −2.8829 | 1.0000 | 1.54094 | 1.0000 | 1.53716 |
| 2 | −1.0689 | −2.2324 | 5.0000 | 1.00000 | 4.7715 | 1.00000 |
| 3 | ∞ | ∞ | 0.0000 | 1.00000 | 0.0000 | 1.00000 |
| 4 | 1.2180 | 1.2180 | 0.9700 | 1.54094 | 0.9700 | 1.53716 |
| 4′ | 1.2537 | 1.2537 | | | | |
| 5 | −5.6375 | −5.6375 | 1.0231 | 1.00000 | 0.6516 | 1.00000 |
| 6 | ∞ | ∞ | 0.6000 | 1.57752 | 1.2000 | 1.57063 |
| 7 | ∞ | ∞ | | | | |

TABLE 2
1^{st} surface

| | |
|---|---|
| Anamorphic aspheric surface | κ_{y} = −5.1300E−01 |
| coefficient | E₄ = −3.6332E−04 |
| | E₆ = −2.1518E−04 |
| | E₈ = 3.6659E−04 |
| | E₁₀ = −5.6249E−05 |
| | κₓ = 1.4460E+00 |
| | F₄ = −6.9572E−01 |
| | F₆ = −8.3139E−01 |
| | F₈ = −4.4219E−01 |
| | F₁₀ = −5.9719E−01 |
| Optical path difference | D_{0.1} = −9.1714E−03 |
| function (Coefficient of | D_{2.0} = 3.9840E−04 |
| optical path difference | D_{0.2} = 9.5373E−04 |
| function: Standard | D_{0.3} = −5.3380E−04 |
| wavelength 655 nm Number of | |
| division 6 steps Shift | |
| amount 1λ Diffraction order | |
| 0-order (655 nm) - primary | |
| order (785 nm)) | |

2^{nd} surface

| | |
|---|---|
| Y-toroidal surface | κ_{y} = −5.3860E−01 |
| coefficient | G₄ = −1.5636E−03 |
| | G₆= −1.6027E−04 |
| | G₈= −3.9083E−05 |

4^{th} surface 0 ≦ h ≦ 0.982

| | |
|---|---|
| Aspheric surface coefficient | κ = −3.3229E−01 |
| | A₄ = −2.9543E−02 |
| | A₆ = −1.6372E−02 |
| | A₈ = 1.6409E−02 |
| | A₁₀ = −1.9058E−02 |
| | A₁₂ = 9.1043E−03 |
| | A₁₄ = −4.5136E−03 |
| Optical path difference | C₄ = −9.4935E−03 |
| function (Coefficient of | C₆ = −6.4660E−03 |
| optical path difference | C₈ = 4.9729E−03 |
| function: Standard | C₁₀ = −2.5032E−03 |
| wavelength 720 nm | |
| Diffraction order primary | |
| order (655 nm) primary order | |
| (785 nm)) | |

4^{th}, surface 0.982 < h

| | |
|---|---|
| Aspheric surface coefficient | κ = −5.8959E−01 |
| | A₄ = −2.0967E−03 |
| | A₆ = 1.4365E−02 |
| | A₈ = −1.4209E−02 |
| | A₁₀ = −7.7771E−03 |
| | A₁₂ = 1.6271E−02 |
| | A₁₄ = −6.2423E−03 |
| Optical path difference | C₂ = −4.5227E−03 |
| function (Coefficient of | C₄ = −4.2858E−03 |
| optical path difference | C₆ = −3.6147E−03 |
| function: Standard | C₈ = −5.4776E−04 |
| wavelength 655 nm | C₁₀ = 1.7019E−03 |
| Diffraction order primary | |
| order (655 nm) primary order | |
| (785 nm)) | |
| 5^{th} surface Aspheric surface | κ = −2.8151E+01 |
| coefficient | A₄ = 1.9036E−02 |
| | A₆ = 3.1214E−02 |
| | A₈ = −4.1707E−02 |
| | A₁₀ = 1.5075E−03 |
| | A₁₂ = 1.3220E−02 |
| | A₁₄ = −4.9303E−03 |

As shown in Table 1, the second laser diode that emits the second light flux having a wavelength of 655 nm is arranged on the optical axis represented by the coordinates (X, Y)=(0.000, 0.000), while, the first laser diode that emits the first light flux having a wavelength of 785 nm is arranged at the position deviated in the Y-axis direction (aforementioned fifth direction) represented by the coordinates (X, Y)=(0.000, 0.110).

A plane of incidence (first surface) of an element wherein a beam regulating element, a light intensity distribution converting element and a collimator are united solidly is composed of an anamorphic aspheric surface prescribed by the numerical formula wherein coefficients shown in Table 1 and Table 2 are substituted in the expression Numeral 1.

$$\begin{matrix}Anamorphic aspheric surface \\ Z = \frac{\frac{{x}^{2}}{{r}_{x}} + \frac{{y}^{2}}{{r}_{y}}}{1 + \sqrt{\{ 1 - ( 1 + {k}_{x} ) \frac{{x}^{2}}{{r}_{x}^{2}} - ( 1 + {k}_{y} ) \frac{{y}^{2}}{{r}_{y}^{2}} \}}} + \\ {\sum }^{} [ {E}_{i} {\{ ( 1 - {F}_{i} ) {x}^{2} + ( 1 + {F}_{i} ) {y}^{2} \}}^{i} ]\end{matrix} \qquad ( Numeral 1 )$$

rx: Radius of curvature in x axis direction, ry: Radius of curvature in y axis direction, κx: Conic constant in x axis direction, κy: Conic constant in y axis direction, Ei: Rotation-symmetrical portion, Fi: Non-rotation-symmetrical portion

Incidentally, in each Table shown below, “−5.1300E−01” means “−5.1300×10⁻¹”.

Further, a diffractive structure prescribed by the numerical formula in which coefficients shown in Table 1 and Table 2 are substituted in Numeral 2 is formed on the first surface, as the third optical path difference providing structure.

(Numeral 2)

Optical Path Difference Function (XY Multinomial)
Φ(x,y)=Σ(Dᵢⱼxⁱy^{j})

A plane of emergence (second surface) of an element wherein a beam regulating element, a light intensity distribution converting element and a collimator are united solidly is composed of Y-toroidal surface prescribed by the numerical formula wherein coefficients shown in Table 1 and Table 2 are substituted in the expression Numeral 3.

$$Y \text{-} toroidal {surface \\ ( z - {r}_{x} )}^{2} + {x}^{2} = \\ [ {r}_{x} - \frac{{y}^{2}}{{r}_{y} \{ 1 + \sqrt{1 - ( 1 + {k}_{y} ) \frac{{y}^{2}}{{r}_{y}^{2}} \}}} + {\sum }^{} ( {G}_{i} {y}^{i} ) ] \qquad ( Numeral 3 )$$

Gi: Non-circular-arc coefficient

A plane of incidence of the objective lens is divided into a concentric-circle-shaped central zone (4^{th} surface) whose height h from the optical axis is in a range of 0≦h≦0.982 with the optical axis serving as a center and a peripheral zone (4′^{th} surface) whose height h satisfies 0.982<h.

The 4^{th} surface is composed of an aspheric surface prescribed by the numerical formula wherein coefficients shown in Table 1 and Table 2 are substituted in the expression Numeral 4.

$$Aspheric surface \\ z = \frac{\frac{{h}^{2}}{r}}{1 + \sqrt{\{ 1 + ( 1 + k ) \frac{{h}^{2}}{{r}^{2}} \}}} + {\sum }^{} ( {A}_{i} {h}^{i} ) \qquad ( Numeral 4 )$$

r: Radius of curvature κ: Conic constant Ai: Aspheric surface coefficient

Further, on the 4^{th} surface, there are formed diffractive ring-shaped zones each having its center on the optical axis, and a pitch of the diffractive ring-shaped zones is prescribed by the numerical formula wherein coefficients shown in Table 1 and Table 2 are substituted for an optical path difference function in Numeral 5.

(Numeral 5)

Optical Path Difference Function (Rotation Symmetry)
Φ(h)=Σ(Cᵢhᵢ)

Incidentally, “standard wavelength” in the Table means the so-called blazed wavelength which is a wavelength wherein the diffraction efficiency of a diffracted light with a certain order that is caused by the diffractive structure comes to the maximum (for example, 100%) when a light flux having that wavelength enters.

Each of the 4′^{th} surface and a plane of emergence (5^{th} surface) of the objective lens is composed of an aspheric surface prescribed by the numerical formula wherein coefficients shown in Table 1 and Table 2 are substituted in the expression Numeral 4.

FIG. 10 is a graph showing radiation characteristics of the second light flux (wavelength λ=655 nm) which has not yet passed the element wherein a beam regulating element, a light intensity distribution converting element and a collimator are united solidly, and FIG. 11 is a graph showing radiation characteristics of the second light flux which has passed the element wherein a beam regulating element, a light intensity distribution converting element and a collimator are united solidly.

### EXAMPLE 2

An optical pickup device in the present example is of the structure wherein a light intensity distribution converting element is not provided. To be concrete, the optical pickup device has compatibility between HD-DVD and DVD. In the light source unit, there are stored a first laser diode and a second laser diode. The first laser diode emits the first light flux having a wavelength of 655 nm for DVD. The second laser diode emits the second light flux having a wavelength of 407 nm for HD-DVD. Each light flux emitted from the light source unit passes successively through a beam regulating element, a beam splitter and a collimator (coupling element), and its diameter is stopped down by a diaphragm member to be converged on a recording surface of each optical disc through an objective lens.

Lens data of each optical element are shown in Table 3 and Table 4.

TABLE 3
Example Lens data

| | |
|---|---|
| 407 nm | 655 nm |

| | X | Y | X | Y |
|---|---|---|---|---|
| Coordinates of | 0.000 | 0.000 | 0.000 | 0.110 |
| light-emitting | | | | |
| point (mm) | | | | |
| NA on the object | 0.145 | 0.058 | 0.149 | 0.060 |
| point side | | | | |
| NA on the image | 0.650 | 0.650 | 0.654 | 0.654 |
| point side | | | | |

| | | |
|---|---|---|
| Wavefront | 0.002λ | 0.020λ |
| aberration | | |

| | | | | ni | di | ni |
|---|---|---|---|---|---|---|
| i^{th} | | | di | (407 | (655 | (655 |
| surface | ryi | rxi | (407 nm) | nm) | nm) | nm) |
| 0 | | | 0.2513 | | 0.2513 | |
| 1 | ∞ | ∞ | 0.2500 | 1.52994 | 0.2500 | 1.51436 |
| 2 | ∞ | ∞ | 1.1857 | 1.00000 | 1.1857 | 1.00000 |
| 3 | −0.4923 | ∞ | 4.0000 | 1.79237 | 4.0000 | 1.76182 |
| 4 | −7.0564 | ∞ | 2.0000 | 1.00000 | 2.0000 | 1.00000 |
| 5 | ∞ | ∞ | 4.5000 | 1.52994 | 4.5000 | 1.51436 |
| 6 | ∞ | ∞ | 3.6386 | 1.00000 | 3.6386 | 1.00000 |
| 7 | 33.6517 | 33.6517 | 2.0000 | 1.52461 | 2.0000 | 1.50673 |
| 8 | −8.7619 | −8.7619 | 5.0000 | 1.00000 | 4.9232 | 1.00000 |
| 9 | ∞ | ∞ | 0.0000 | 1.00000 | 0.0000 | 1.00000 |
| 10 | 1.9327 | 1.9327 | 1.8500 | 1.55981 | 1.8500 | 1.54073 |
| 11 | −11.3206 | −11.3206 | 1.5567 | 1.00000 | 1.6335 | 1.00000 |
| 12 | ∞ | ∞ | 0.6000 | 1.61869 | 0.6000 | 1.57752 |
| 13 | ∞ | ∞ | 0.0000 | 1.00000 | 0.0000 | 1.00000 |

TABLE 4
3^{rd} surface

| | |
|---|---|
| Y-toroidal surface coefficient | κ_{y} = 0.0000E+00 |

4^{th} surface

| | |
|---|---|
| Y-toroidal surface coefficient | κ_{y} = −2.4248E+00 |

8^{th} surface

| | |
|---|---|
| Aspheric surface coefficient | κ = −1.0000E−01 |
| | A₄ = 1.4697E−04 |
| | A₆ = 1.6010E−06 |
| Optical path difference | C₂ = −6.2137E−04 |
| function (Coefficient of | |
| optical path difference | |
| function: Standard wavelength | |
| 407 nm Number of division 5 | |
| steps Shift amount 2λ | |
| Diffraction order 0-order (407 nm) | |
| primary order (655 nm)) | |

10^{th} surface

| | |
|---|---|
| Aspheric surface coefficient | κ = −5.4726E−01 |
| | A₄ = 3.7831E−04 |
| | A₆ = −1.8413E−03 |
| | A₈ = 6.4043E−04 |
| | A₁₀ = −9.8987E−05 |
| | A₁₂ = −1.1518E−06 |
| | A₁₄ = −7.9320E−07 |
| Optical path difference | C₂ = −7.7249E−04 |
| function (Coefficient of | C₄ = −2.0466E−04 |
| optical path difference | C₆ = −8.5677E−05 |
| function: Standard wavelength | C₈ = 2.6999E−05 |
| 422 nm Diffraction order 8^{th} | C₁₀ = −4.1167E−06 |
| order (407 nm) 5^{th} order | |
| (655 nm)) | |

11^{th} surface

| | |
|---|---|
| Aspheric surface coefficient | κ = −3.3066E+02 |
| | A4 = −3.7387E−03 |
| | A6 = 8.8025E−03 |
| | A8 = −5.2282E−03 |
| | A10 = 1.4815E−03 |
| | A12 = −2.1825E−04 |
| | A14 = 1.3236E−05 |

As shown in Table 3, the second laser diode that emits the second light flux having a wavelength of 407 nm is arranged on the optical axis represented by the coordinates (X, Y)=(0.000, 0.000), while, the first laser diode that emits the first light flux having a wavelength of 655 nm is arranged at the position deviated in the Y-axis direction (aforementioned fifth direction) represented by the coordinates (X, Y)=(0.000, 0.110).

Each of a plane of incidence (third surface) and a plane of emergence (fourth surface) of a beam regulating element is composed of Y-toroidal surface prescribed by the numerical formula wherein coefficients shown in Table 3 and Table 4 are substituted in the expression Numeral 3.

A plane of emergence (eighth surface) of the collimator is composed of an aspheric surface prescribed by the numerical formula wherein coefficients shown in Table 3 and Table 4 are substituted in the expression Numeral 4.

Further, on the 8^{th} surface, there are formed diffractive ring-shaped zones each having its center on the optical axis, and a pitch of the diffractive ring-shaped zones is prescribed by the numerical formula wherein coefficients shown in Table 3 and Table 4 are substituted for an optical path difference function in Numeral 5.

A plane of incidence (tenth surface) of the objective lens is composed of an aspheric surface prescribed by the numerical formula wherein coefficients shown in Table 3 and Table 4 are substituted in the expression Numeral 4.

Further, on the 10^{th} surface, there are formed diffractive ring-shaped zones each having its center on the optical axis, and a pitch of the diffractive ring-shaped zones is prescribed by the numerical formula wherein coefficients shown in Table 3 and Table 4 are substituted for an optical path difference function in Numeral 5.

A plane of emergence (eleventh surface) of an objective lens is composed of an aspheric surface prescribed by the numerical formula wherein coefficients shown in Table 3 and Table 4 are substituted in the expression Numeral 4.

### EXAMPLE 3

An optical pickup device in the present example is of the structure wherein a light intensity distribution converting element is not provided, which is the same as Example 2. To be concrete, the optical pickup device has compatibility between HD-DVD and DVD. In the light source unit, there are stored a first laser diode and a second laser diode. The first laser diode emits the first light flux having a wavelength of 655 nm for DVD. The second laser diode emits the second light flux having a wavelength of 407 nm for HD-DVD. Each light flux emitted from the light source unit passes successively through a beam regulating element, a beam splitter and a collimator (coupling element), and its diameter is stopped down by a diaphragm member to be converged on a recording surface of each optical disc through an objective lens.

Lens data of each optical element are shown in Table 5 and Table 6.

TABLE 5
Example Lens data

| | |
|---|---|
| 407 nm | 655 nm |

| | X | Y | X | Y |
|---|---|---|---|---|
| Coordinates of | 0.000 | 0.000 | 0.000 | 0.110 |
| light-emitting | | | | |
| point (mm) | | | | |
| NA on the object | 0.145 | 0.058 | 0.148 | 0.060 |
| point side | | | | |
| NA on the image | 0.650 | 0.650 | 0.654 | 0.654 |
| point side | | | | |

| | | |
|---|---|---|
| Wavefront | 0.004λ | 0.013λ |
| aberration | | |

| | | | | ni | di | ni |
|---|---|---|---|---|---|---|
| i^{th} | | | di | (407 | (655 | (655 |
| surface | ryi | rxi | (407 nm) | nm) | nm) | nm) |
| 0 | | | 0.2513 | | 0.2513 | |
| 1 | ∞ | ∞ | 0.2500 | 1.52994 | 0.2500 | 1.51436 |
| 2 | ∞ | ∞ | 1.1866 | 1.00000 | 1.1866 | 1.00000 |
| 3 | ∞ | 1.2311 | 4.0000 | 1.79237 | 4.0000 | 1.76182 |
| 4 | ∞ | 2.8211 | 2.0000 | 1.00000 | 2.0000 | 1.00000 |
| 5 | ∞ | ∞ | 4.5000 | 1.52994 | 4.5000 | 1.51436 |
| 6 | ∞ | ∞ | 24.0048 | 1.00000 | 24.0048 | 1.00000 |
| 7 | 55.0911 | 55.0911 | 2.0000 | 1.52461 | 2.0000 | 1.50673 |
| 8 | −25.6862 | −25.6862 | 5.0000 | 1.00000 | 4.9237 | 1.00000 |
| 9 | ∞ | ∞ | 0.0000 | 1.00000 | 0.0000 | 1.00000 |
| 10 | 1.9327 | 1.9327 | 1.8500 | 1.55981 | 1.8500 | 1.54073 |
| 11 | −11.3206 | −11.3206 | 1.5567 | 1.00000 | 1.6330 | 1.00000 |
| 12 | ∞ | ∞ | 0.6000 | 1.61869 | 0.6000 | 1.57752 |
| 13 | ∞ | ∞ | 0.0000 | 1.00000 | 0.0000 | 1.00000 |

TABLE 6
3^{rd} surface

| | |
|---|---|
| X-toroidal surface | κₓ = −2.3135E+00 |
| coefficient | H₄ = 6.4855E−03 |
| Optical path difference | D_{2.0} = −5.157E−03 |
| function (Coefficient of | |
| optical path difference | |
| function: Standard wavelength | |
| 407 nm Number of division 5 | |
| steps Shift amount 2λ | |
| Diffraction order 0-order | |
| (407 nm) primary order (655 nm)) | |

4^{th} surface

| | |
|---|---|
| X-toroidal surface | κₓ = −6.2651E−01 |
| coefficient | H₄ = 5.3486E−02 |

8^{th} surface

| | |
|---|---|
| Aspheric surface coefficient | κ = −1.0000E−01 |
| | A₄ = 1.2842E−05 |
| Optical path difference | C₂ = −2.8583E−04 |
| function (Coefficient of | |
| optical path difference | |
| function: Standard wavelength | |
| 407 nm Number of division 5 | |
| steps Shift amount 2λ | |
| Diffraction order 0-order | |
| (407 nm) primary order (655 nm)) | |

10^{th} surface

| | |
|---|---|
| Aspheric surface coefficient | κ = −5.4726E−01 |
| | A₄ = 3.7831E−04 |
| | A₆ = −1.8413E−03 |
| | A₈ = 6.4043E−04 |
| | A₁₀ = −9.8987E−05 |
| | A₁₂ = −1.1518E−06 |
| | A₁₄ = −7.9320E−07 |
| Optical path difference | C₂ = −7.7249E−04 |
| function (Coefficient of | C₄ = −2.0466E−04 |
| optical path difference | C₆ = −8.5677E−05 |
| function: Standard wavelength | C₈ = 2.6999E−05 |
| 422 nm Diffraction order 8^{th} | C₁₀ = −4.1167E−06 |
| order (407 nm) 5^{th} order (655 nm)) | |

11^{th} surface

| | |
|---|---|
| Aspheric surface coefficient | κ = −3.3066E+02 |
| | A₄ = −3.7387E−03 |
| | A₆ = 8.8025E−03 |
| | A₈ = −5.2282E−03 |
| | A₁₀ = 1.4815E−03 |
| | A₁₂ = −2.1825E−04 |
| | A₁₄ = 1.3236E−05 |

As shown in Table 5, the second laser diode that emits the second light flux having a wavelength of 407 nm is arranged on the optical axis represented by the coordinates (X, Y)=(0.000, 0.000), while, the first laser diode that emits the first light flux having a wavelength of 655 nm is arranged at the position deviated in the Y-axis direction (aforementioned fifth direction) represented by the coordinates (X, Y)=(0.000, 0.110).

A plane of incidence (third surface) of the beam regulating element is composed of X-toroidal surface prescribed by the numerical formula wherein coefficients shown in Table 5 and Table 6 are substituted in the expression Numeral 6.

$$X \text{-} toroidal {surface \\ ( z - {r}_{y} )}^{2} + {y}^{2} = \\ [ {r}_{y} - \frac{{x}^{2}}{{r}_{x} \{ 1 + \sqrt{1 - ( 1 + {k}_{x} ) \frac{{x}^{2}}{{r}_{x}^{2}}} \}} + \sum ( {H}_{i} {x}^{i} ) ] \qquad ( Numeral 6 )$$

Hi: Non-circular-arc coefficient

Further, a diffractive structure prescribed by the numerical formula in which coefficients shown in Table 5 and Table 6 are substituted in Numeral 2 is formed on the third surface, as the third optical path difference providing structure. This diffractive structure is of a structure wherein the first optical function portion extending straight along the direction (third direction) perpendicular to the optical axis L is arranged continuously in the direction (fourth direction) perpendicular to the third direction, and the fourth direction and X direction are arranged to agree with each other. Incidentally, though the first optical function portion 70 is divided into three steps in FIG. 5, the number of division in the present example is five.

A plane of emergence (fourth surface) of the beam regulating element is composed of X-toroidal surface prescribed by the numerical formula wherein coefficients shown in Table 5 and Table 6 are substituted in the expression Numeral 6.

A plane of emergence (eighth surface) of the collimator is composed of an aspheric surface prescribed by the numerical formula wherein coefficients shown in Table 3 and Table 4 are substituted in the expression Numeral 4.

Further, on the 8^{th} surface, there are formed diffractive ring-shaped zones each having its center on the optical axis, and a pitch of the diffractive ring-shaped zones is prescribed by the numerical formula wherein coefficients shown in Table 5 and Table 6 are substituted for an optical path difference function in Numeral 5.

A plane of incidence (tenth surface) of the objective lens is composed of an aspheric surface prescribed by the numerical formula wherein coefficients shown in Table 5 and Table 6 are substituted in the expression Numeral 4.

Further, on the 10^{th} surface, there are formed diffractive ring-shaped zones each having its center on the optical axis, and a pitch of the diffractive ring-shaped zones is prescribed by the numerical formula wherein coefficients shown in Table 5 and Table 6 are substituted for an optical path difference function in Numeral 5.

A plane of emergence (eleventh surface) of an objective lens is composed of an aspheric surface prescribed by the numerical formula wherein coefficients shown in Table 5 and Table 6 are substituted in the expression Numeral 4.

### EXAMPLE 4

An optical pickup device in the present example is of the structure wherein a light intensity distribution converting element is not provided, which is the same as Example 3. To be concrete, the optical pickup device has compatibility for HD-DV, DVD and CD. The structure of the pickup device is shown in FIG. 12.

This pickup device is one wherein the optical pickup device shown in FIG. 4 has been modified. Points of modification will be explained. In casing 23, there are stored first laser diode 21, second laser diode 22 and third laser diode 24. Incidentally, on the drawing in FIG. 12, the one arranged on the left side is the first laser diode 21, the one arranged on the right side is the second laser diode 22 and the one arranged at the center is the third laser diode 24. In the present example, collimator 12 and beam regulating element 40 are arranged to be a separate optical element.

The first laser diode emits the first light flux having a wavelength of 785 nm for CD. The second laser diode emits the second light flux having a wavelength of 655 nm for DVD. The third laser diode emits the third light flux having a wavelength of 408 nm for HD-DVD. Each light flux emitted from the light source unit passes successively through a beam regulating element, a collimator (coupling element) and a beam splitter, and its diameter is stopped down by a diaphragm member to be converged on a recording surface of each optical disc through an objective lens.

Lens data of each optical element are shown in Table 7 and Table 8.

TABLE 7-1

| | 407 nm | | 655 nm | | 785 nm | |
|---|---|---|---|---|---|---|
| | X | Y | X | Y | X | Y |
| Coordinates of | 0.000 | 0.000 | 0.000 | 0.110 | 0.000 | −0.110 |
| light-emitting | | | | | | |
| point (mm) | | | | | | |
| NA on the object | 0.185 | 0.074 | 0.185 | 0.075 | 0.147 | 0.060 |
| point side | | | | | | |
| NA on the image | 0.650 | 0.650 | 0.651 | 0.651 | 0.495 | 0.496 |
| point side | | | | | | |

| | | | |
|---|---|---|---|
| Wavefront | 0.001λ | 0.003λ | 0.006λ |
| aberration | | | |

TABLE 7-2

| i^{th} | | | di | ni | di | ni | di | ni |
|---|---|---|---|---|---|---|---|---|
| surface | ryi | rxi | (407 nm) | (407 nm) | (655 nm) | (655 nm) | (785 nm) | (785 nm) |
| 0 | | | 1.9000 | | 1.9000 | | 1.9000 | |
| 1 | −0.5386 | ∞ | 3.7500 | 1.81585 | 3.7500 | 1.78066 | 3.7500 | 1.77391 |
| 2 | −5.8614 | ∞ | 5.7879 | 1.00000 | 6.0199 | 1.00000 | 6.4331 | 1.00000 |
| 3 | 38.2677 | 38.2677 | 2.0000 | 1.52446 | 2.0000 | 1.50673 | 2.0000 | 1.50345 |
| 4 | −6.5926 | −6.5926 | 5.0000 | 1.00000 | 4.6796 | 1.00000 | 4.9697 | 1.00000 |
| 5 | ∞ | ∞ | 0.1000 | 1.00000 | 0.1000 | 1.00000 | 0.0000 | 1.00000 |
| 6 | 1.9638 | 1.9638 | 1.7600 | 1.55830 | 1.7600 | 1.53938 | 1.7600 | 1.53589 |
| 7 | −10.7427 | −10.7427 | 1.7227 | 1.00000 | 1.8111 | 1.00000 | 1.5210 | 1.00000 |
| 8 | ∞ | ∞ | 0.6000 | 1.61829 | 0.6000 | 1.57752 | 1.2000 | 1.57063 |
| 9 | ∞ | ∞ | 0.0000 | 1.00000 | 0.0000 | 1.00000 | 0.0000 | 1.00000 |

TABLE 8
1^{st} surface

| | |
|---|---|
| Y-toroidal surface | κᵥ = 0.0000E+00 |
| coefficient | |
| Optical path difference | D_{0.1} = 5.7798E−02 |
| function (Coefficient of | D_{0.2} = −3.2333E−03 |
| optical path difference | D_{2.1} = −7.9472E−03 |
| function: Standard wavelength | D_{0.3} = 2.0888E−02 |
| 655 nm Diffraction order 0- | |
| order (407 nm) primary order | |
| (655 nm) 0-order (785 nm) | |
| Number of division 5 steps | |
| Shift amount 2λ (λ = 408 nm)) | |

2^{nd} surface

| | |
|---|---|
| Y-toroidal surface | κᵥ = 9.7903E−01 |
| coefficient | H₄ = 1.3698E−03 |
| Optical path difference | D_{0.1} = −1.1218E−02 |
| function (Coefficient of | D_{0.2} = 5.4993E−05 |
| optical path difference | D_{2.1} = 4.7280E−04 |
| function: Standard wavelength | D_{0.3} = 9.6712E−05 |
| 785 nm Diffraction order 0- | |
| order (407 nm) 0-order (655 nm) | |
| primary order (785 nm) | |
| Number of division 2 steps | |
| Shift amount 5λ (λ = 408 nm)) | |

4^{th} surface

| | |
|---|---|
| Aspheric surface coefficient | κ = −1.0000E−01 |
| | A₄ = 2.8000E−04 |
| | A₆ = 5.6757E−06 |

6^{th} surface

| | |
|---|---|
| Aspheric surface coefficient | κ = −5.4894E−01 |
| | A₄ = 1.0603E−03 |
| | A₆ = −1.3250E−03 |
| | A₈ = 5.0847E−04 |
| | A₁₀ = −3.9760E−05 |
| | A₁₂ = −1.4261E−05 |
| | A₁₄ = 1.1184E−06 |
| Optical path difference | C₂ = −5.4303E−04 |
| function (Coefficient of | C₄ = −5.8842E−05 |
| optical path difference | C₆ = −1.7645E−04 |
| function: Standard wavelength | C₈ = 5.1044E−05 |
| 417 nm Diffraction order 3^{rd} | C₁₀ = −6.1711E−06 |
| order (408 nm) Secondary | |
| order (655 nm) Secondary | |
| order (785 nm)) | |

11^{th} surface

| | |
|---|---|
| Aspheric surface coefficient | κ = −2.2653E+02 |
| | A₄ = −8.3958E−03 |
| | A₆ = 1.0917E−02 |
| | A₈ = −5.3410E−03 |
| | A₁₀ = 1.3141E−03 |
| | A₁₂ = −1.6618E−04 |
| | A₁₄ = 8.5718E−06 |

As shown in Table 7, the third laser diode that emits the third light flux having a wavelength of 408 nm is arranged on the optical axis represented by the coordinates (X, Y)=(0.000, 0.000), the second laser diode that emits the second light flux having a wavelength of 655 nm is arranged at the position deviated in the Y-axis direction (aforementioned fifth direction) represented by the coordinates (X, Y)=(0.000, 0.110) and the first laser diode that emits the first light flux having a wavelength of 785 nm is arranged at the position deviated in the Y-axis direction (aforementioned fifth direction) represented by the coordinates (X, Y)=(0.000, −0.110).

Each of a plane of incidence (first surface) and a plane of emergence (second surface) of the beam regulating element is composed of Y-toroidal surface prescribed by the numerical formula wherein coefficients shown in Table 7 and Table 8 are substituted in the expression Numeral 3. Further, on each of the third surface and the fourth surface, there is formed a diffractive structure which is prescribed by the numerical expression wherein coefficients shown in Table 7 and Table 8 are substituted for an optical path function of Numeral 2.

A plane of emergence (fourth surface) of the collimator is composed of an aspheric surface prescribed by the numerical formula wherein coefficients shown in Table 7 and Table 8 are substituted in the expression Numeral 4.

A plane of incidence (sixth surface) of the objective lens is composed of an aspheric surface prescribed by the numerical formula wherein coefficients shown in Table 7 and Table 8 are substituted in the expression Numeral 4. Further, on the 6^{th} surface, there are formed diffractive ring-shaped zones each having its center on the optical axis, and a pitch of the diffractive ring-shaped zones is prescribed by the numerical formula wherein coefficients shown in Table 7 and Table 8 are substituted for an optical path difference function in Numeral 5.

A plane of emergence (seventh surface) of the objective lens is composed of an aspheric surface prescribed by the numerical formula wherein coefficients shown in Table 7 and Table 8 are substituted in the expression Numeral 4.

It is to be noted that various changes and modifications will be apparent to those skilled in the art. Therefore, unless such changes and modifications depart from the scope of the present invention, they should be construed as being included therein.

1. An optical pickup apparatus comprising:
a light source unit including a plurality of light emitting elements provided to be closed each other, wherein each of the light emitting elements emits a light flux, wherein the light fluxes have a different wavelength each other;
a beam regulating element to regulate the light flux emitted from the light source unit so that the an angle of divergence of the light flux emitted from the light source unit is changed to a first direction and/or a'second direction, wherein the first direction is perpendicular to an optical axis, and the second direction is perpendicular to both of the optical axis and the first direction;
a coupling element to convert the angle of divergence of the light flux;
an objective optical element to converge the light flux coming from the coupling element on an recording surface of an optical information recording medium to form a light-converged spot on the optical information recording medium; and
a light-receiving element to receive reflected light from the light-converged spot so that the light-receiving element converts the reflected light into an electric signal,
wherein a distance from each of the light emitting element to a surface of a protective layer that protects the recording surface is constant regardless a type of the optical information recording medium, and
a first light flux is used to form the light-converged spot for the optical information recording medium having a thick protective layer, while, a second light flux is used to form the light-converged spot for the optical information recording medium having a thin protective layer, wherein the first light flux has a longer wavelength than the light fluxes except for the first light flux, and the second light flux has a shorter wavelength than the light fluxes except for the second light flux.

2. The optical pickup device of claim 1, wherein the beam regulating element and the coupling element are united solidly.

3. The optical pickup device of claim 1, wherein the beam regulating element and the coupling element are composed of one element that has functions for both of them.

4. The optical pickup device of claim 1, wherein the beam regulating element and the objective optical element are provided separately each other.

5. The optical pickup device of claim 1, wherein all of the beam regulating element, the coupling element and the objective optical element are made of plastic.

6. An optical pickup apparatus comprising:
a light source unit including a plurality of light emitting elements provided to be closed each other, wherein each of the light emitting elements emits a light flux, wherein the light fluxes have a different wavelength each other;
a light intensity distribution converting element to convert a light intensity of a light flux to the desired light intensity within a range of 45-95% of the light intensity of the light flux passing through the optical axis position, wherein the light flux is passed through the outermost peripheral portion of an effective diameter in the light fluxes emitted from the light source unit, and intensity distribution of the light fluxes emitted from the light source unit is substantially Gaussian distribution;
a coupling element to convert the angle of divergence of the light flux;
an objective optical element to converge the light flux coming from the coupling element on an recording surface of an optical information recording medium to form a light-converged spot on the optical information recording medium; and
a light-receiving element to receive reflected light from the light-converged spot so that the light-receiving element converts the reflected light into an electric signal,
wherein a distance from each of the light emitting element to a surface of a protective layer that protects the recording surface is constant regardless a type of the optical information recording medium, and
a first light flux is used to form the light-converged spot for the optical information recording medium having a thick protective layer, while, a second light flux is used to form the light-converged spot for the optical information recording medium having a thin protective layer, wherein the first light flux has a longer wavelength than the light fluxes except for the first light flux, and the second light flux has a shorter wavelength than the light fluxes except for the second light flux.

7. The optical pickup device of claim 6, wherein the light intensity distribution converting element and the coupling element are united solidly.

8. The optical pickup device of claim 6, wherein the light intensity distribution converting element and the coupling element are composed of one element that has functions for both of them.

9. The optical pickup device of claim 6, wherein the light intensity distribution converting element and the objective optical element are provided separately each other.

10. The optical pickup device of claim 6, wherein all of the light intensity distribution converting element, the coupling element and the objective optical element are made of plastic.

11. An optical pickup apparatus comprising:
a light source unit including a plurality of light emitting elements provided to be closed each other, wherein each of the light emitting elements emits a light flux, wherein the light fluxes have a different wavelength each other;
a beam regulating element to regulate the light flux emitted from the light source unit so that the an angle of divergence of the light flux emitted from the light source unit is changed to a first direction and/or a second direction, wherein the first direction is perpendicular to an optical axis, and the second direction is perpendicular to both of the optical axis and the first direction;
a light intensity distribution converting element to convert a light intensity of a light flux to the desired light intensity within a range of 45-95% of the light intensity of the light flux passing through the optical axis position, wherein the light flux is passed through the outermost peripheral portion of an effective diameter in the light fluxes emitted from the light source unit, and intensity distribution of the light fluxes emitted from the light source unit is substantially Gaussian distribution;
a coupling element to convert the angle of divergence of the light flux;
an objective optical element to converge the light flux coming from the coupling element on an recording surface of an optical information recording medium to form a light-converged spot on the optical information recording medium; and
a light-receiving element to receive reflected light from the light-converged spot so that the light-receiving element converts the reflected light into an electric signal,
wherein a distance from each of the light emitting element to a surface of a protective layer that protects the recording surface is constant regardless a type of the optical information recording medium, and
a first light flux is used to form the light-converged spot for the optical information recording medium having a thick protective layer, while, a second light flux is used to form the light-converged spot for the optical information recording medium having a thin protective layer, wherein the first light flux has a longer wavelength than the light fluxes except for the first light flux, and the second light flux has a shorter wavelength than the light fluxes except for the second light flux.

12. The optical pickup device of claim 11, wherein the beam regulating element, the light intensity distribution converting element and the coupling element are united solidly.

13. The optical pickup device of claim 11, wherein the beam regulating element, the light intensity distribution converting element and the coupling element are composed of one element that has functions for all of them.

14. The optical pickup device of claim 11, wherein the beam regulating element and the light intensity distribution converting element are united solidly.

15. The optical pickup device of claim 11, wherein the beam regulating element and the light intensity distribution converting element are composed of one element that has functions for both of them.

16. The optical pickup device of claim 11, wherein the beam regulating element and the coupling element are united solidly.

17. The optical pickup device of claim 11, wherein the beam regulating element and the coupling element are composed of one element that has functions for both of them.

18. The optical pickup device of claim 11, wherein the light intensity distribution converting element and the coupling element are united solidly.

19. The optical pickup device of claim 11, wherein the light intensity distribution converting element and the coupling element are composed of one element that has functions for both of them.

20. The optical pickup device of claim 11, wherein the beam regulating element and the objective optical element are provided separately each other.

21. The optical pickup device of claim 11, wherein the light intensity distribution converting element and the objective optical element are provided separately each other.

22. The optical pickup device of claim 11, wherein all of the beam regulating element, the light intensity distribution converting element and the coupling element are made of plastic.
